(19) United States
(12) Patent Application Publication
(10) Pub. No.: US 2006/0023405 A1
(43) Pub. Date: Feb. 2, 2006

(54) Port replicator having display function

(76) Inventor: Ming-Yang Lin, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/902,951

(22) Filed: Aug. 2, 2004

(51) Int. Cl. G06F 1/16

(52) U.S. Cl. 361/681

(57) ABSTRACT

A port replicator having display function includes a signal transmission device located in a case which has a housing compartment and an opening on one side, and a display device having a display panel and connecting electrically to the signal transmission device to display signals received by the signal transmission device. The case has a latch tenon structure to prevent a portable electronic device coupled with the signal transmission device from slipping out of the case.

### FIELD OF THE INVENTION

The present invention relates to a port replicator having display function and particularly to a port replicator which serves as an additional input expansion interface of a portable electronic device and also has display function at the same time.

### BACKGROUND OF THE INVENTION

With the conveniences brought by computers, people's work and daily life are directly affected. Due to the requirements for mobile host grow constantly, portable electronic devices have been developed. Among them notebook computers have become the main stream products on the market. Their slim size and light weight free people from the constraint of working area.

Slim and light are the prevailing trend of the computer market these days, but the capability of connecting peripheral devices and hardware expansion is still constrained. Hence many notebook computers or portable hosts now provide a mating port replicator or docking port. For instance, R.O.C. patent No. 241915 discloses a transferable modular dock replicator for portable computers or other peripheral devices. Refer to FIG. 1 for a conventional port replicator which couples with a portable device. A notebook computer 10′ has a signal transmission connection slot (not shown in the drawing) on a desired location to facilitate expansion of peripheral devices. The connection ports related to the peripheral devices that are originally located on the notebook computer 10′ are transferred to a port replicator 20′ so that the notebook computer 10′ does not lose the expandability of the peripheral devices and the carrying convenience even its size and weight are reduced.

While the portability and expansion convenience have been enhanced, the size of the host shrinks. As a result, the display picture also is smaller. This causes uncomfortable reading for users.

In view of the problem set forth above, the present invention aims to provide an improvement.

### SUMMARY OF THE INVENTION

The primary object of the invention is to provide a port replicator that has display function to couple with a portable electronic device and provide expansion of output devices and/or display function in selected environments.

Another object of the invention is to provide a port replicator with display function that has a housing compartment in a case to house a portable electronic device and a latch tenon structure to anchor the portable electronic device to prevent the portable electronic device from slipping out of the case under shaking or in an inclined condition.

The port replicator with display function according to the invention serves as an expansion interface of a portable electronic device. It includes a signal transmission device located in a case which has a housing compartment and an opening on one side thereof leading to the housing compartment, and a display device which has a display panel and is connected electrically to the signal transmission device to display signals received by the signal transmission device. The case further includes a latch tenon structure to prevent the portable electronic device coupled with the signal transmission device from slipping out of the case.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional technique.

FIG. 2 is a perspective view of the port replicator of the invention and a portable electronic device before assembly.

FIG. 3 is a front view of the case of the invention and a portable electronic device in an assembled condition.

FIG. 4 is a fragmentary top view of the case of the invention and a portable electronic device during assembling.

FIG. 5 is a fragmentary top view of the case of the invention and a portable electronic device after assembled.

FIG. 6 is a fragmentary front view of another embodiment of the case of the invention and a portable electronic device.

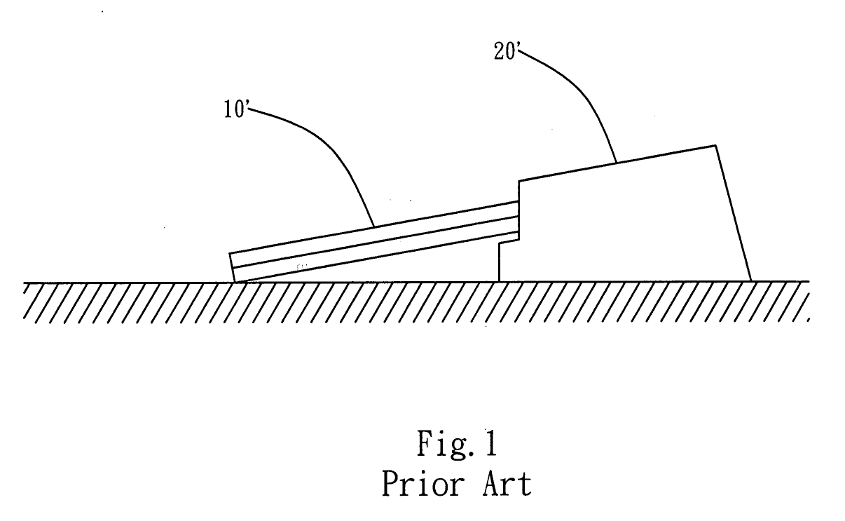

### DESCRIPTION OF THE PREFERRED EMBODIMENTS

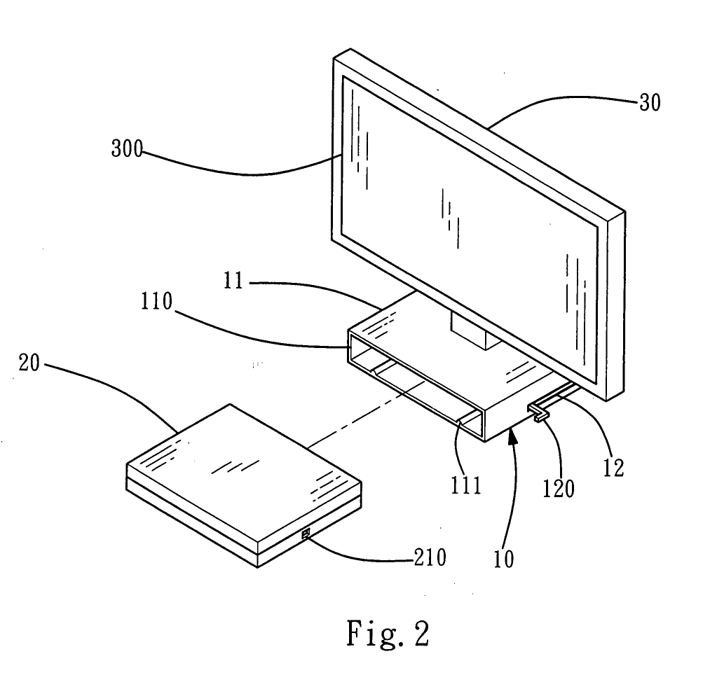

Refer to FIG. 2 for an embodiment of the port replicator of the invention and a portable electronic device before assembly. The port replicator includes a signal transmission device 10 located in a case 11. The case 11 has a housing compartment 110 and an opening on one side thereof leading to the housing compartment 110. The case 11 has selected connection ports (not shown in the drawing) on another side, such as a Universal Serial Bus (USB), Line PrinTer port (LPT), communication port (COM port) or PS/2 port, etc. Yet another side of the case 11 adjacent to the opening has a latch tenon structure 12 which is formed in L-shape. The latch tenon structure 12 has an axis coupling on the case 11, and one end pivotally coupled with a handle 120 which has a latch element 121, and another end turnable in the housing compartment 110. A display device 30 such as LCD display device is provided that has a display panel 300. The display device 30 is electrically connected to the signal transmission device 10 to display signals received by the signal transmission device 10.

Referring to FIG. 2, a portable electronic device 20 (such as notebook computer) may be housed in the housing compartment 110 of the case 11 to connect electrically with the signal transmission device 10. The latch element 121 is wedged in a cavity 210 on the portable electronic device 20. Hence during output signals are transmitted from the portable electronic device to the signal transmission device 10 or other output devices, the portable electronic device 20 may be prevented from slipping out of the housing compartment 110.

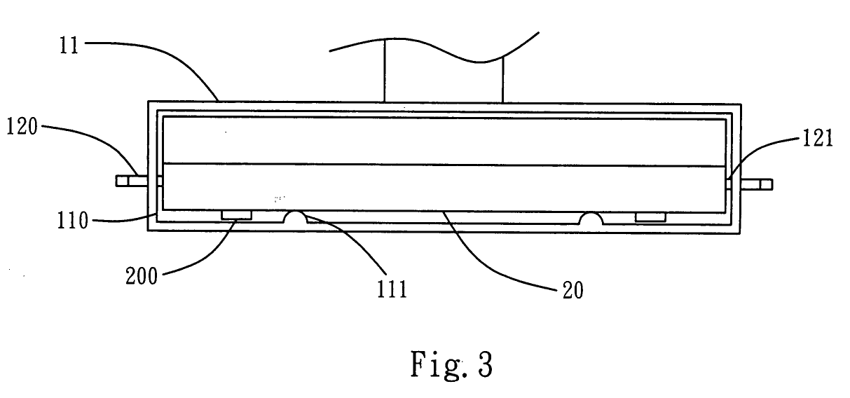

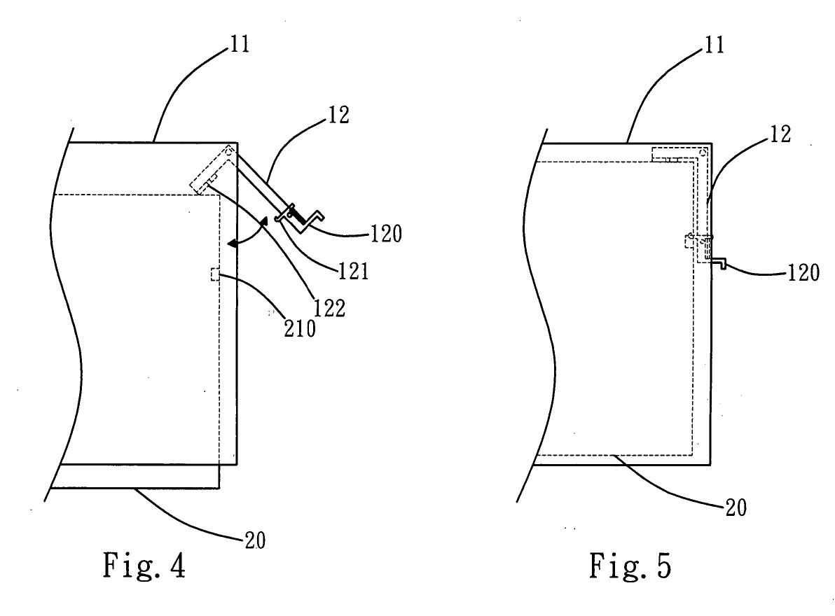

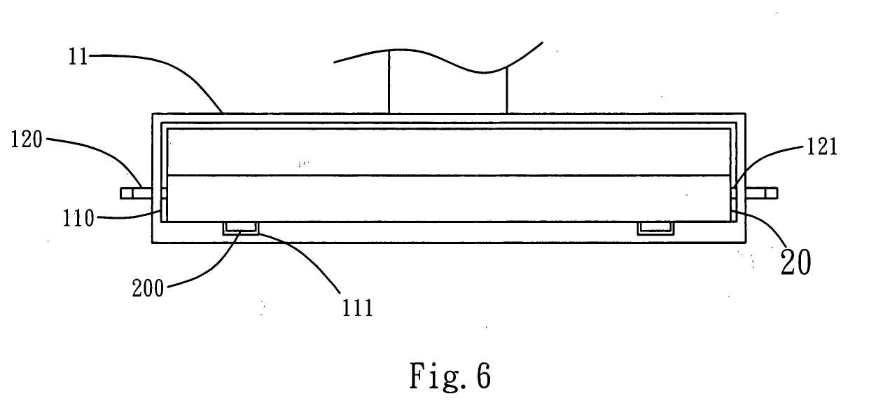

Referring to FIGS. 3, 4 and 5, The housing compartment 110 of the case 11 has two elongate tracks 111 to reduce the friction force occurred to rubber pads 200 located on the bottom side of the portable electronic device 20 during moving into the housing compartment 110 by suspending the rubber pads 200. The tracks 111 may be jutting into the housing compartment 111 or indented on the housing compartment 111 (referring to FIG. 6). Referring to FIG. 4, when the portable electronic device 20 is pushed into the housing compartment 110, it contacts the latch tenon structure 12. A buffer pad 122 may be added on the latch tenon structure on the contact surface to prevent the portable electronic device 20 from directly hitting the latch tenon structure 12 and result in damage. The latch tenon structure 12 has a bending section pivotally coupled in the case 11.

When the portable electronic device 20 pushes the latch tenon structure 12, the latch tenon structure 12 receive a force and turns about the pivotal axis until the portable electronic device 20 is coupled with a connection slot (not shown in the drawings) of the signal transmission device 10 (referring to FIG. 2) to form an electric connection. At that moment, the latch tenon structure 12 stops turning and the latch element 121, such as a pin, on the handle 120 of another end of the latch tenon structure 12 is latched on a corresponding trough 210 located on the portable electronic device 20 so that the portable electronic device 20 and the port replicator may be coupled together, and the portable electronic device 20 functions as the host of the entire device, and the display panel 300 of the device 30 which is larger than the displace device (not shown in the drawings) of the portable electronic device 20 may be used. Hence when a user leaves home or office, he/she can remove the portable electronic device 20 from the port replicator to make carrying easier. When the user comes back to home or office, he/she can couple the portable electronic device 20 with the port replicator to use the larger display panel 300.

To remove the portable electronic device 20 from the case 11, pull the handle 120 outwards (shown by the outward arrow direction in FIG. 4) to separate the latch element 121 from the cavity 210 of the portable electronic device 20, then move the latch tenon structure 12 further to push the portable electronic device 20 outwards from the case 10.

The port replicator thus constructed enables user of the portable electronic device to use a more desirable display device in different working environments. The case equipped with the latch tenon structure makes coupling and/or separating of the portable electronic device and the port replicator easier.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A port replicator having display function, comprising:
a signal transmission device located in a case which has a housing compartment and an opening on one side leading to the housing compartment; and
a display device having a display panel and being electrically connected to the signal transmission device to display signals received by the signal transmission device.

2. The port replicator of claim 1, wherein the case has at least one latch tenon structure on another side adjacent to the opening.

3. The port replicator of claim 2, wherein the tenon structure is formed in L-shape and has an axis pivotally coupled on the case, one end pivotally coupled to a handle which has a latch element and another end turnable in the housing compartment.

4. The port replicator of claim 3, wherein the housing compartment is allowed to house a portable electronic device which has a cavity engageable with the latch element.

5. The port replicator of claim 4, wherein the portable electronic device connects electrically to the signal transmission device after being housed in the housing compartment to transmit signals thereof to the display device for displaying.

6. The port replicator of claim 1, wherein the housing compartment has at least one elongate track.

7. The port replicator of claim 6, wherein the track is jutting from the surface of the housing compartment.

8. The port replicator of claim 6, wherein the track is indented from the surface of the housing compartment.

9. The port replicator of claim 1, wherein the case has an expansion connection port located on another side other than where the opening is formed.

10. The port replicator of claim 1, wherein the display device is a liquid crystal display device.

11. The port replicator of claim 4, wherein the portable electronic device is a notebook computer.

12. The port replicator of claim 9, wherein the connection port is a Universal Serial Port (USB), a Line PrinTer port (LPT port), a communication port (COM), or a PS/2 port.
